(19) United States
(12) Patent Application Publication
(10) Pub. No.: US 2020/0314555 A1
(43) Pub. Date: Oct. 1, 2020

(54) ELECTRO-ACTIVE LOUDSPEAKER

(71) Applicant: Harman Becker Automotive Systems GmbH, Karlsbad (DE)

(72) Inventor: Gerhard PFAFFINGER, Regensburg (DE)

(73) Assignee: Harman Becker Automotive Systems GmbH, Karlsbad (DE)

(21) Appl. No.: 15/781,008

(22) PCT Filed: Dec. 4, 2015
(86) PCT No.: PCT/EP2015/078688

§ 371 Date: Jun. 1, 2018

(51) Int. Cl. H04R 17/00; H04R 5/02; H04R 19/02; H04R 7/10; H04R 7/12

(52) U.S. Cl. CPC H04R 17/005; H04R 5/02; H04R 2307/025; H04R 7/10; H04R 7/125; H04R 19/02

(57) ABSTRACT

An electroactive loudspeaker includes a conductive carrier plate comprising a first main surface and a second main surface, the first main surface and the second main surface being disposed on opposite sides of the carrier plate. The electroactive loudspeaker further includes an electroactive polymer layer comprising a first main surface and a second main surface. An electrically conductive electrode layer is attached to the second main surface of the electroactive polymer layer. The first surface of the carrier plate has an area and the first surface of the electroactive polymer layer has an area, the area of the first surface of the carrier plate being larger than the area of the first surface of the electroactive polymer layer. The first main surface of the electroactive polymer layer overlaps in its entire area with the first main surface of the carrier plate.

### FIELD

The disclosure relates to electro-active loudspeakers, particularly to shallow electro-active loudspeakers, and to systems including electro-active loudspeakers.

### BACKGROUND

Acoustic actuators most commonly act as sources for producing sound, i.e., are used as loudspeakers. The most common of these acoustic actuators or loudspeakers are electromagnetic-based and electrostatic-based loudspeakers.

Electromagnetic actuators include permanent magnets and copper coils which can be relatively heavy and have relatively high profiles, even for low-power applications. The higher the spatial resolution desired from a loudspeaker, the greater the number of electromagnetic actuators required. Accordingly, for applications requiring high spatial resolution but with weight and volume limitations, such as in automotive and aerospace applications, electromagnetic acoustic actuators are impractical. Electromagnetic actuators, however, require a sufficient back volume to avoid an “acoustic short circuit” between the front side and the rear side of the loudspeaker.

Electrostatic loudspeakers are constructed with two electrode plates having different electrical potentials and positioned with a narrow air gap in between, with air being used as the dielectric medium. To produce sound, one of the plates is held stationary and the other is moved relative to the stationary plate. The movable plate is electrostatically attracted to the stationary plate. While electrostatic loudspeakers are lightweight and can be made to have a relatively low profile, they have several disadvantages for many applications. These loudspeakers tend to be costly since it is necessary to carefully construct the loudspeaker so that the moving plate does not contact the stationary plate, but with an air gap small enough so that the required driving voltage is not excessive. Also, electrostatic loudspeakers require some sort of acoustic front rear decoupling. Additionally, because the radiating plate must maintain a nearly constant spacing from a rigid stationary plate, these loudspeakers are limited to flat-mounted applications. Further, as electrostatic loudspeakers typically operate with a bias voltage of several thousand volts, limitations on the driving voltage will also limit the acoustic power output.

Loudspeakers using non-electroactive polymers such as piezoelectric ceramics and relatively rigid polymer materials as the dielectric layer are also known. With these loudspeakers, sound is produced primarily by changing the thickness of the polymer layer (or stack of layers) due to the electrostrictive or piezoelectric effect. The polymer dielectric allows greater power output (per loudspeaker surface area and weight) than air-gap-based electrostatic loudspeakers at a given voltage. As the electrostatic energy is multiplied by the dielectric constant of the polymer, the polymer dielectric has a greater breakdown voltage than air in practical designs. Thus, since the applied voltage can be greater than that generated by air-gap devices, the electric field will also be greater, further increasing the power output capabilities of the actuator. Loudspeakers using non-electroactive polymers exhibit a weakness in reproducing lower frequency sound.

U.S. Pat. Nos. 6,343,129 and 7,608,989 disclose loudspeakers using electroactive polymers having low moduli of elasticity in which the in-plane strains of the compliant electroactive polymer dielectric are used to induce out-of-plane deflection of the layer to produce sound. The stiffness and mass of polymer layers operating in this out-of-plane configuration are orders of magnitude less than that for compression of the more rigid polymers used in the electrostrictive and piezoelectric devices mentioned above. This allows for higher acoustic output per surface area and per weight at lower driving voltages than is possible with other electrostatic devices. Loudspeakers with elastomeric polymer layers can be made in a wide variety of form factors, i.e., they can be conformed to any shape or surface, they are very lightweight and have very low-profiles that can be unobtrusively located on walls, ceilings or other surfaces, and they are relatively easy to manufacture and use low cost materials. There is great interest in the improvement of the performance of loudspeakers with electroactive polymer layers as well as other acoustic applications.

### SUMMARY

An electroactive loudspeaker includes a rigid, electrically conductive carrier plate comprising a first main surface and a second main surface, the first main surface and the second main surface being disposed on opposite sides of the carrier plate. The electroactive loudspeaker further includes an electroactive polymer layer comprising a first main surface and a second main surface, the first main surface of the electroactive polymer layer being attached to the first main surface of the carrier plate. An electrically conductive electrode layer is attached to the second main surface of the electroactive polymer layer. The first surface of the carrier plate has an area and the first surface of the electroactive polymer layer has an area, the area of the first surface of the carrier plate being larger than the area of the first surface of the electroactive polymer layer. The first main surface of the electroactive polymer layer overlaps in its entire area with the first main surface of the carrier plate.

A loudspeaker system comprising at least one electroactive loudspeaker and a housing in which the electroactive loudspeaker is disposed.

### BRIEF DESCRIPTION OF THE DRAWINGS

The disclosure may be better understood from reading the following description of non-limiting embodiments to the attached drawings, in which like elements are referred to with like reference numbers, wherein below:

FIG. 1 is a top perspective view illustrating an exemplary simple electroactive loudspeaker;

FIG. 2 is a cross-sectional side view illustrating an exemplary electroactive loudspeaker with a rigid carrier plate;

FIG. 3 is a top view of the electroactive loudspeaker shown in FIG. 2;

FIG. 4 is a cross-sectional side view illustrating an exemplary electroactive loudspeaker with a rigid carrier plate and stacked polymer-electrode combinations;

FIG. 5 is a cross-sectional side view illustrating an exemplary electroactive loudspeaker with a curved rigid carrier plate and curved polymer-electrode combinations;

FIG. 6 is a top view illustrating loudspeaker system with an electroactive loudspeaker and at least one non-electroactive loudspeaker;

FIG. 7 is a back view of the electroactive loudspeaker shown in FIG. 6;

FIG. 8 is a front view of the electroactive loudspeaker shown in FIG. 6;
and

FIG. 9 is a top view of an electroactive loudspeaker with helical wound shape.

### DETAILED DESCRIPTION

Before describing particular examples of electroactive loudspeakers and loudspeaker systems, a discussion of the basic principles of electroactive polymer loudspeakers and their material properties and performance characteristics is provided.

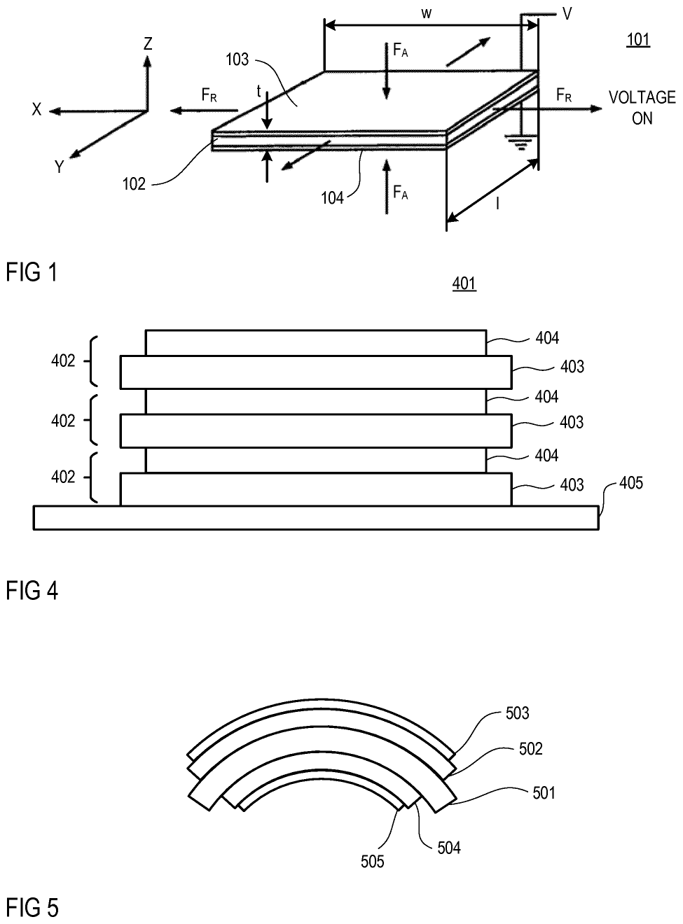

FIG. 1 illustrates a simple electroactive loudspeaker 101. A portion of thin elastomeric polymer layer 102, also commonly referred to as a layer or membrane, is sandwiched between compliant electrodes 103 and 104. In this elastomeric polymer loudspeaker, the elastic modulus of the electrodes 103 and 104 is generally less than that of the polymer, and the length “1” and width “w” of the polymer layer 102 are much greater than the thickness “t”. When a voltage is applied across the electrodes 103 and 104, the unlike charges in the two electrodes 103 and 104 are attracted to each other and electrostatic attractive forces FA compress the polymer layer 102 along a Z-axis perpendicular to the surface of the electrodes 103 and 104 along X-axis and Y-axis. Repulsive forces FR between like charges in each electrode tend to stretch the polymer layer 102 in the plane along the X and Y-axes. The effective actuation pressure on the polymer layer 102 depends on the relative dielectric constant of the polymer layer 102, the dielectric constant of free space, the electric field (equal to the applied voltage divided by the layer thickness) and Young's modulus of elasticity. The effective pressure includes the effect of both the electrostatic attractive forces FA and repulsive forces FR.

As loudspeaker 101 changes in size, the deflection may be used to produce mechanical work. Generally speaking, deflection refers to any displacement, expansion, contraction, torsion, linear or area strain, or any other deformation of a portion of the loudspeaker. Loudspeaker 101 continues to deflect until mechanical forces balance the electrostatic forces driving the deflection. The mechanical forces include elastic restoring forces of the polymer material, the compliance of the electrodes 103 and 104, and any external resistance provided by a device and/or load coupled to the loudspeaker 101. The resultant deflection of the loudspeaker 101 as a result of an applied voltage V may also depend on a number of other factors such as the polymer dielectric constant and the polymer size and stiffness.

In some cases, electrodes 103 and 104 cover a limited portion of a polymer relative to the total area of the polymer layer 102. As the term is used herein, an active region is defined as a portion of the polymer material having sufficient electrostatic force to enable deflection of the portion. Polymer 102 material outside an active area may act as an external spring force on the active area during deflection. More specifically, material outside the active area may resist active area deflection by its contraction or expansion. Removal of the voltage difference and the induced charge causes the reverse effects.

Exemplary polymer 102 is compliant. Suitable polymers may have an elastic modulus less than 100 MPa, and in some cases in the range 0.1 to 10 MPa. Polymers having a maximum actuation pressure, defined as the change in force within a polymer per unit cross-sectional area between actuated and unactuated states, between 0.05 MPa and 10 MPa, and particularly between 0.3 MPa and 3 MPa are useful for many applications. In contrast, a rigid carrier may have an elastic modulus more than 1000 MPa or even more than 10,000 MPa.

Polymer materials may be selected based on one or more material properties or performance characteristics, including but not limited to a low modulus of elasticity, a high dielectric constant, strain, energy density, actuation pressure, specific elastic energy density, electromechanical efficiency, response time, operational frequency, resistance to electrical breakdown and adverse environmental effects, etc. Polymers having dielectric constants between about 2 and about 20, and particularly between about 2.5 and about 12, are also suitable. Specific elastic energy density—defined as the energy of deformation of a unit mass of the material in the transition between actuated and unactuated states—may also be used to describe an electroactive polymer where weight is important. Polymer layer 102 may have a specific elastic energy density of over 3 J/g. The performance of polymer 102 may also be described by efficiency—defined as the ratio of mechanical output energy to electrical input energy. Electromechanical efficiency greater than about 80 percent is achievable with some polymers.

Linear strain and area strain may be used to describe deflection of compliant polymers used herein. Linear strain may refer to the deflection per unit length along a line of deflection relative to the unactuated state. Maximum linear strains (tensile or compressive) of at least about 25 percent are common for polymers. Maximum linear strains (tensile or compressive) of at least about 50 percent are common. Of course, a polymer may deflect with a strain less than the maximum and the strain may be adjusted by adjusting the applied voltage. For some polymers, maximum linear strains in the range of about 40 to about 215 percent are common, and are more commonly at least about 100 percent. Area strain of an electroactive polymer refers to the change in planar area, e.g., the change in the plane defined by the X and Y-axes in FIG. 1, per unit area of the polymer upon actuation relative to the unactuated state. Maximum area strains of at least about 100 percent are possible. For some polymers (at low frequencies), maximum area strains in the range of about 70 to about 330 percent are possible.

The time for a polymer to rise (or fall) to its maximum (or minimum) actuation pressure is referred to as its response time. Polymer 102 may accommodate a wide range of response times. Depending on the size and configuration of the polymer, response times may range from about 0.01 milliseconds to 1 second, for example. A polymer excited at a high rate may also be characterized by an operational frequency. Maximum suitable operational frequencies may be in the range of about 100 Hz (or lower) to 100 kHz. Operational frequencies in this range allow polymer 102 to be used in various acoustic applications (e.g., loudspeakers). In some exemplary applications, polymer 102 may be operated at a resonant frequency to improve mechanical output.

It should be noted that desirable material properties for an electroactive polymer may vary with an application. To produce a large actuation pressure and large strain for an application, a polymer 102 may be implemented with one of a high dielectric strength, a high dielectric constant, and a low modulus of elasticity. Additionally, a polymer may include one of a high-volume resistivity and low mechanical damping for maximizing energy efficiency for an application.

Polymer materials that may be used for polymer 102 include but are not limited to: acrylic elastomer, silicone elastomer, polyurethane, polyvinylidene fluoride (PVDF) copolymer and adhesive elastomer. For example, the polymer is an acrylic elastomer comprising mixtures of aliphatic acrylate that are photocured during fabrication. The elasticity of the acrylic elastomer results from a combination of the branched aliphatic groups and cross-linking between the acrylic polymer chains. Exemplary materials suitable for use as polymer 102 may include any dielectric elastomeric polymer, silicone rubbers, fluoroelastomers, silicones, fluorosilicones, acrylic polymers, etc. Other suitable polymers may include one or more of: silicone, acrylic, polyurethane, fluorosilicone, fluoroelastomer, natural rubber, polybutadiene, nitrile rubber, isoprene, styrene-butadiene-styrene, Kraton, and ethylene propylene diene.

Polymer 102 may also include one or more additives to improve various properties or parameters related to the ability of the polymer to convert electrical energy into mechanical energy. Such material properties and parameters include but are not limited to the dielectric breakdown strength, maximum strain, dielectric constant, elastic modulus, properties associated with the viscoelastic performance, properties associated with creep, response time and actuation voltage. Examples of classes of materials which may be used as additives include but are not limited to plasticizers, antioxidants, and high dielectric constant particulates.

The addition of a plasticizer may, for example, improve the functioning of a loudspeaker by reducing the elastic modulus of the polymer and/or increasing the dielectric breakdown strength of the polymer. Examples of suitable plasticizers include high molecular-weight hydrocarbon oils, high molecular-weight hydrocarbon greases, hydrocarbon resins, silicone oils, silicone greases, silicone elastomers, nonionic surfactants, and the like. Of course, combinations of these materials may be used. Alternatively, a synthetic resin may be added to a styrene-butadiene-styrene block copolymer to improve the dielectric breakdown strength of the copolymer. Certain types of additives may be used to increase the dielectric constant of a polymer. For example, high dielectric constant particulates such as fine ceramic powders may be added to increase the dielectric constant of a commercially available polymer. Alternatively, polymers such as polyurethane may be partially fluorinated to increase the dielectric constant.

An additive may be included in a polymer to reduce the elastic modulus of the polymer. Reducing the elastic modulus enables larger strains for the polymer. In a specific example, mineral oil was added to a polymer to reduce the elastic modulus of the polymer. In this case, the ratio of mineral oil added may range from about 0 to 2:1 by weight. Specific materials included to reduce the elastic modulus of an acrylic polymer include any acrylic acids, acrylic adhesives, acrylics including flexible side groups such as isooctyl groups and 2-ethylhexyl groups, or any copolymer of acrylic acid and isooctyl acrylate.

Multiple additives may be included in a polymer to improve performance of one or more material properties. In one example, mineral oil and pentalyn-H were both added to a polymer to increase the dielectric breakdown strength and to reduce the elastic modulus of the polymer. Alternatively, for a commercially available silicone rubber whose stiffness has been increased by fine particles used to increase the dielectric constant, the stiffness may be reduced by the addition of silicone grease.

An additive may also be included in a polymer to provide an additional property for the loudspeaker. The additional property is not necessarily associated with polymer performance in converting between mechanical and electrical energy. By way of example, pentalyn-H may be added to a polymer to provide an adhesive property to the polymer. In this case, the additive also aids the conversion between mechanical and electrical energy. In a specific example, polymers comprising pentalyn-H, mineral oil and butyl acetate provide an adhesive polymer and a maximum linear strain in the range of about 70 to about 200 percent.

Polymer 102 may be pre-strained to improve conversion between electrical and mechanical energy. The pre-strain improves the mechanical response of an electroactive polymer relative to a non-strained electroactive polymer. The improved mechanical response, e.g., larger deflections, faster response times, and higher actuation pressures, enables greater mechanical work. The pre-strain may comprise elastic deformation of the polymer and be formed, for example, by stretching the polymer in tension and fixing one or more of the edges to a frame while stretched or may be implemented locally for a portion of the polymer. Linear strains of at least about 200 percent and area strains of at least about 300 percent are possible with pre-strained polymers. The pre-strain may vary in different directions of a polymer. Combining directional variability of the pre-strain, different ways of constraining a polymer, scalability of electroactive polymers to both micro and macro levels, and different polymer orientations (e.g., rolling or stacking individual polymer layers) permits a broad range of actuators that convert electrical energy into mechanical work.

The desired performance of an electroactive loudspeaker may be controlled by the extent of pre-strain applied to the polymer layer and the type of polymer material used. For some polymers, pre-strain in one or more directions may range from about −100 percent to about 600 percent. The pre-strain may be applied uniformly across the entire area of the polymer layer or may be unequally applied in different directions. In one example, pre-strain is applied uniformly over a portion of the polymer 102 to produce an isotropic pre-strained polymer. By way of example, an acrylic elastomeric polymer may be stretched by about 200 to about 400 percent in both planar directions. In another example, pre-strain is applied unequally in different directions for a portion of the polymer 102 to produce an anisotropic pre-strained polymer. In this case, the polymer 102 may deflect more in one direction than in another when actuated. By way of example, for a VHB acrylic elastomer having isotropic pre-strain, pre-strains of at least about 100 percent, and preferably between about 200 to about 400 percent, may be used in each direction. In one example, the polymer is pre-strained by a factor in the range of about 1.5 times to about 50 times the original area. In some cases, pre-strain may be added in one direction such that a negative pre-strain occurs in another direction, e.g., 600 percent in one direction coupled with 100 percent in an orthogonal direction. In these cases, the net change in area due to the pre-strain is typically positive.

While not wishing to be bound by theory, it is believed that pre-straining a polymer in one direction may increase the stiffness of the polymer in the pre-strain direction. Correspondingly, the polymer is relatively stiffer in the high pre-strain direction and more compliant in the low pre-strain direction and, upon actuation, the majority of deflection occurs in the low pre-strain direction. By way of example, the loudspeaker 101 may enhance deflection along the Y-axes by exploiting large pre-strain along the X-axes, and an acrylic elastomeric polymer used as the loudspeaker 10 may be stretched by 100 percent along the Y-axis and by 500 percent along the X-axis. Construction of the loudspeaker 101 and geometric edge constraints may also affect directional deflection.

Pre-strain may affect other properties of the polymer. Large pre-strains may change the elastic properties of the polymer and bring it into a stiffer regime with lower viscoelastic losses. For some polymers and layers, pre-strain increases the electrical breakdown strength of the polymer, which allows for higher electric fields to be used within the polymer, thereby permitting higher actuation pressures and higher deflections.

Polymers may cover a wide range of thicknesses. In one example, polymer thickness may range between about 1 micrometer and about 2 millimeters. For example, typical thicknesses before pre-strain range for different polymers from about 50 to about 225 micrometers, about 25 to about 75 micrometers, or about 100 to about 1000 micrometers. Polymer thickness may be reduced by stretching the layer in one or both planar directions. In many cases, pre-strained polymers may be fabricated and implemented as thin layers. Thicknesses suitable for these thin layers may be below 20 micrometers.

In addition to the material composition of a polymer for use in an electroactive loudspeaker, the physical texture of the polymer surface can play a role in the performance of the loudspeaker. Electroactive polymers may include a textured surface, e.g., a wavelike profile. The textured surface allows the polymer to deflect by using the bending of surface waves. Bending of the surface waves provides directional compliance in a direction with less resistance than bulk stretching for a stiff electrode attached to the polymer in the direction. The textured surface may include troughs and crests, for example, about 0.1 micrometer to about 40 micrometers wide and about 0.1 micrometers to about 20 micrometers deep. In this case, the wave width and depth is substantially less than the thickness of the polymer. The troughs and crests may be approximately 10 micrometers wide and six micrometers deep on a polymer layer with a thickness of about 200 micrometers.

In another example, a thin layer of stiff material, such as an electrode, may be attached to the polymer to provide a wavelike profile. During fabrication, the electroactive polymer is stretched more than it can stretch when actuated, and the thin layer of stiff material is attached to the stretched polymer surface. Subsequently, the polymer is relaxed and the structure buckles to provide the textured surface. In general, a textured surface may comprise any non-uniform or non-smooth surface topography that allows a polymer to deflect using deformation in the polymer surface. Deformation in surface topography may allow deflection of a stiff electrode with less resistance than bulk stretching or compression. It should be noted that deflection of a pre-strained polymer having a textured surface may comprise a combination of surface deformation and bulk stretching of the polymer.

Textured or non-uniform surfaces for the polymer may also allow the use of a barrier layer and/or electrodes that rely on deformation of the textured surfaces. The electrodes may include metals that bend according to the geometry of the polymer surface. The barrier layer may be used to block the movement of electrical charges which may prevent or delay local electrical breakdown in the polymer material. Generally speaking, electrodes suitable for use with the present loudspeakers may be of any shape and material provided they are able to supply and/or receive a suitable voltage, either constant or varying over time, to or from an electroactive polymer. For example, the electrodes adhere to a surface of the polymer. Electrodes adhering to the polymer are preferably compliant and conform to the changing shape of the polymer. The electrodes may be only applied to a portion of an electroactive polymer and define an active area according to their geometry.

For example, compliant electrodes comprise a conductive grease such as carbon grease or silver grease. The conductive grease provides compliance in multiple directions. Particles may be added to increase the conductivity of the polymer. By way of example, carbon particles may be combined with a polymer binder such as silicone to produce a carbon grease that has low elasticity and high conductivity. Other materials may be blended into the conductive grease to alter one or more material properties. For example, a suitable electrode comprises 80 percent carbon grease and 20 percent carbon black in a silicone rubber binder. The conductive grease may also be mixed with an elastomer, such as a silicon elastomer to provide a gel-like conductive grease.

Compliant electrodes may also include colloidal suspensions. Colloidal suspensions contain submicrometer sized particles, such as graphite, silver and gold, in a liquid or elastomeric vehicle. Generally speaking, any colloidal suspension having sufficient loading of conductive particles may be used as an electrode. For example, a conductive grease including colloidal sized conductive particles is mixed with a conductive silicone including colloidal sized conductive particles in a silicone binder to produce a colloidal suspension that cures to form a conductive semi-solid. An advantage of colloidal suspensions is that they may be patterned on the surface of a polymer by spraying, dip coating and other techniques that allow for a thin uniform coating of a liquid. To facilitate adhesion between the polymer and an electrode, a binder may be added to the electrode. By way of example, a water-based latex rubber or silicone may be added as a binder to a colloidal suspension including graphite.

In another example, compliant electrodes are achieved using a high aspect ratio conductive material such as carbon fibrils and carbon nanotubes. These high aspect ratio carbon materials may form high surface conductivities in thin layers. High aspect ratio carbon materials may impart high conductivity to the surface of the polymer at relatively low electrode thicknesses due to the high interconnectivity of the high aspect ratio carbon materials. By way of example, thicknesses for electrodes made with common forms of carbon that are not high-aspect ratio may be in the range of about 2 to about 50 micrometers while thicknesses for electrodes made with carbon fibril or carbon nanotube electrodes may be less than about 0.5 to about 4 micrometers. Area expansions well over 100 percent in multiple directions are suitable with carbon fibril and carbon nanotube electrodes on acrylic and other polymers. High aspect ratio carbon materials may include the use of a polymer binder to increase adhesion with the electroactive polymer layer. The use of polymer binder allows a specific binder to be selected based on adhesion with a particular electroactive polymer layer and based on elastic and mechanical properties of the polymer.

In another example, mixtures of ionically conductive materials may be used for the compliant electrodes. This may include, for example, water based polymer materials such as glycerol or salt in gelatin, iodine-doped natural rubbers and water-based emulsions to which organic salts such as potassium iodide are added. For hydrophobic electroactive polymers that may not adhere well to a water based electrode, the surface of the polymer may be pretreated by plasma etching or with a fine powder such as graphite or carbon black to increase adherence. In some cases, a loudspeaker may implement two different types of electrodes.

Generally speaking, desirable properties of the compliant electrodes may include: a low modulus of elasticity, low mechanical damping, a low surface resistivity, uniform resistivity, chemical and environmental stability, chemical compatibility with the electroactive polymer, good adherence to the electroactive polymer, and an ability to form smooth surfaces. It is understood that certain electrode materials may work well with particular polymers and may not work as well for others. By way of example, carbon fibrils work well with acrylic elastomer polymers but not as well with silicone polymers. In some cases, it may be desirable for the electrode material to be suitable for precise patterning during fabrication. By way of example, the compliant electrode may be spray coated onto the polymer. In this case, material properties which benefit spray coating would be desirable.

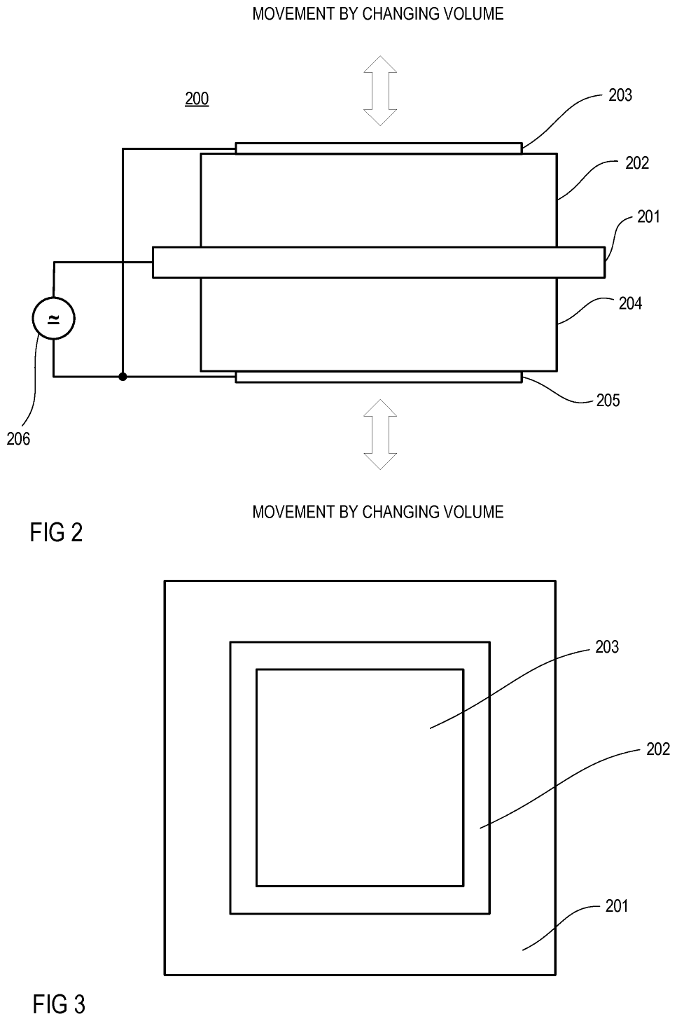

Referring now to FIG. 2, an exemplary electroactive loudspeaker 200 includes a rigid, electrically conductive carrier plate 201 such as a (thick) metal plate. Alternatively carrier plate 201 may be made from metal alloy, metalized ceramics or even rigid, electrically non-conductive material with some sort of an electrically conductive surface. An electroactive polymer layer 202, which has a first main surface and a second main surface, is attached through its first main surface to one surface of the carrier plate 201. An electrically conductive electrode layer is attached to the second main surface of the electroactive polymer layer 202. The electrical and mechanical connection between the polymer layer 202 and the carrier plate 201 may be established by an electrically adhesive or soldering of metal or metalized surfaces of the carrier plate 201 and the polymer layer 202. Various options for constructing the polymer layer 202 and the electrically and mechanically connection between the polymer layer 202 and the electrode layer 203 are described further above and can be applied in the present example accordingly. The polymer layer 202 may be made from a dielectric elastomer, an electrostrictive polymer, an electro-chemo-mechanical conducting polymer, mechano-chemical polymer or piezoelectric polymer. The electrode layer 203 may be spray coated onto the polymer layer 202.

Small loudspeakers mounted in a small enclosure conventionally exhibit a poor performance particularly at lower sound frequencies due to the little backside volume. The loudspeaker 200 shown in FIG. 2 requires practically no backside volume for a satisfying reproduction of lower-frequency sound. Loudspeaker 200 can be designed to be very thin and to have a relatively large surface, wherein the spatial volume of the electroactive material is controlled by a (high) voltage supplied to the electroactive material. When controlled by electrical signals with a voltage corresponding to the sound to be radiated, the loudspeaker 201 exhibits time-dependent spatial-volume variations with an acoustic impedance that is closer to the acoustic impedance of the air so that the sound is emitted very efficiently. In contrast, conventional loudspeakers emit sound by variation of the speed of a membrane.

In the electroactive loudspeaker 200 shown in FIG. 2, the movement of the polymer layer 202 due to the volume increase or decrease of the polymer layer 202 applies a mechanical impulse to the carrier plate 201. If it is desired to reduce this impulse to (almost) zero, optionally another polymer layer 204 with an electrode layer 205 may be attached to a side of the carrier plate 201 opposite to the side at which the polymer layer 204 is attached. The polymer layer 204 and the electrode layer 205 may be arranged axisymmetrically to the arrangement of the polymer layer 202 and the electrode layer with respect to the longitudinal axis of the carrier plate 201.

As can be seen from the top view of electroactive loudspeaker 200 shown in FIG. 3, the first main surface of the carrier plate 201 has an area and the first surface of the electroactive polymer layer has an area and the area of the first surface of the carrier plate 201 is larger than the area of the first surface of the electroactive polymer layer 202. Furthermore, the electrode layer 203 may have an area that is smaller than the area of the second surface of the electroactive polymer layer 202. As can be seen from FIGS. 2 and 3, the first main surface of the electroactive polymer layer 202 overlaps in its entire area with the first main surface of the carrier plate 201. In the case that a symmetrical arrangement in connection with polymer layer 204 and electrode layer 205 is used, the above dimensioning applies to polymer layer 204 and electrode layer 205 accordingly. A controllable voltage source 206, e.g., an amplifier, supplies the loudspeaker 200 with a voltage which may be the sum of an AC signal (e.g., music or speech) and a DC bias signal that defines the bias point of the electroactive loudspeaker 200. The carrier plate 201 receives one electric potential and the electrodes 203 and 205 the other electric potential of voltage source 206.

Referring to FIG. 4, a multilayered electroactive polymer stack 401 may be used instead of a single polymer-electrode combination with polymer layer 202 and electrode layer 203 as shown in FIG. 2. The stack 401 includes a plurality of layer combinations 402 that are stacked on top of each other, in which each of the plurality of layer combinations 402 includes an electroactive polymer layer 403 and an electrode layer 404. The multilayered polymer stack 401 may have a structure in which a plurality of layer combinations 402 are laminated on top of each other while alternately interposing between them driving electrode layers that have different electric potentials. A first one of layer combinations 402 is attached to a rigid, metal carrier plate 405. If the active electrode is formed using a metal having a high rigidity, the flexural modulus of the multilayered polymer stack 401, which has a plurality of active electrode layers, is substantially increased and the displacement of the polymer stack 401 is reduced. In order to minimize the reduction in the displacement of a polymer stack 401, the electrode layers 404 may be formed in a small thickness of several tens of nanometers. Alternatively, in order to minimize the reduction in the displacement of polymer stack 401, the electrode layers 404 may be formed using a conductive polymer instead of metal. The electrode layers 404 may be formed of conductive polymer or metal material including at least one selected from the group consisting of gold (Au), copper (Cu), silver (Ag), aluminum (Al), nickel (Ni), chrome (Cr), iron (Fe), and combinations thereof. When the electrode layers 404 are formed using a metal material, the metal material may be deposited along a general deposition scheme, such as by sputtering and physical vapor deposition (PVD). As in the example described above in connection with FIG. 2, a symmetrical arrangement of two stacks on opposite sides of carrier plate 405 is possible as well. Furthermore, like the carrier plate 201 shown in FIGS. 2 and 3, the carrier plate 405 may not only have a cuboid shape but also a cylindrical shape (not shown) or any other shape (not shown).

As shown in FIG. 5, in another exemplary loudspeaker the surface of a carrier plate 501 and so, too, the surfaces of an electroactive polymer layer 502 and an electrode layer 503 may be designed to have a curved shape such as an arch or a dome shape. Again, as in the example described above in connection with FIG. 2, a symmetrical arrangement of an optional other polymer-electrode combination with a polymer layer 504 and an electrode layer 505 at an opposite side of carrier plate 501 is possible as well.

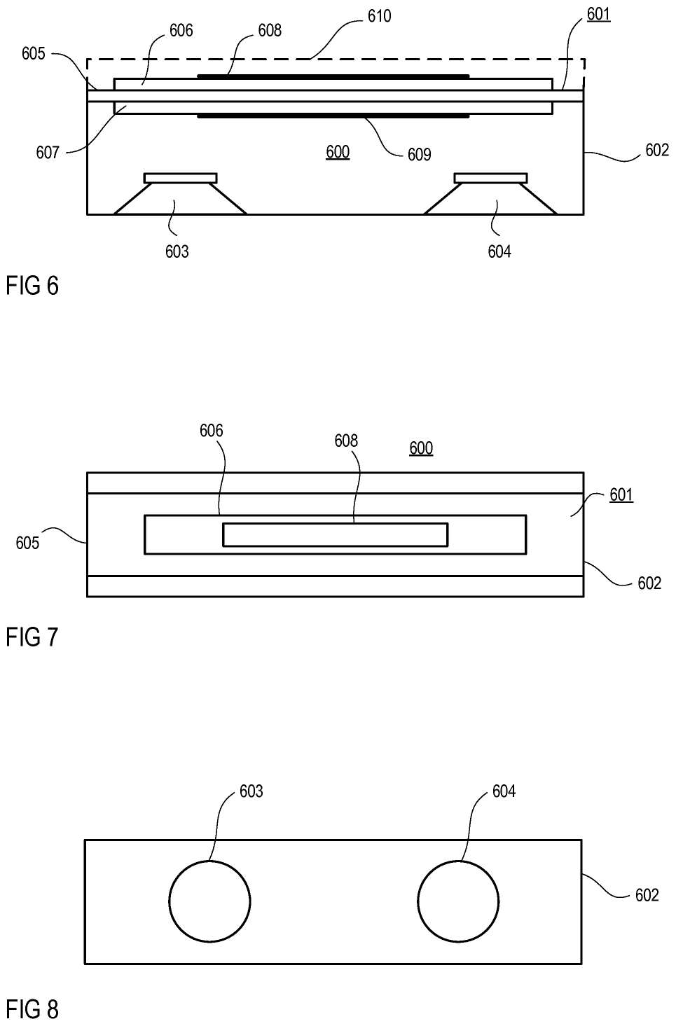

Referring to FIGS. 6, 7 and 8, which illustrate a top view, back view and front view, an exemplary loudspeaker system 600 includes one electroactive loudspeaker 601 (or optionally more electroactive loudspeakers) disposed in a housing 602 together with at least one non-electroactive loudspeaker such as loudspeakers 603 and 604. The non-electroactive loudspeakers 603 and 604 may be arranged on the front side of the housing 602. The electroactive loudspeaker 601 may be arranged on the backside of the housing 602 and may include two polymer-electrode combinations on both sides of a carrier plate 605. The polymer-electrode combinations include polymer layers 606, 607 and corresponding electrode layers 608, 609. The carrier plate 605 forms the rear side of the housing 602 so that polymer-electrode combination 606, 608 is outside and polymer-electrode combination 607, 609 is disposed inside the housing 602. Furthermore, a sound permeable grille 610 may be disposed at the rear side of the housing 602 for mechanically protecting the electroactive loudspeaker 601 to the rear. The non-electroactive loudspeakers 603 and 604 may include an electro-dynamic loudspeaker, electro-magnetic loudspeaker, electro-static loudspeaker, and piezo-electric loudspeaker.

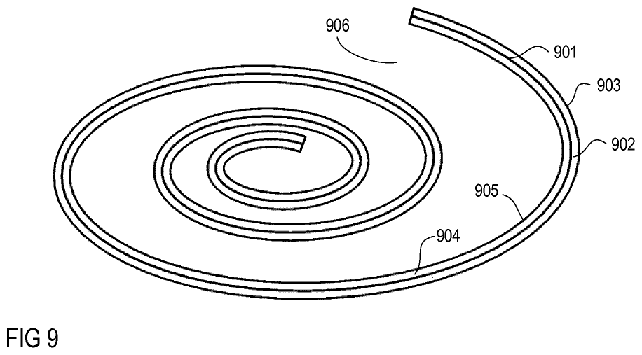

FIG. 9 illustrates an electroactive loudspeaker with a carrier plate 901, one electroactive polymer layer 902, 904 on either side of the carrier plate 901 and one electrode layer 903, 905 on top of the electroactive polymer layers 902 and 904. The carrier plate 901, the polymer layer 902 and 904, and the electrode layers 903 and 905 are wound to form helical windings with an air gap, e.g., a channel 906, between adjacent windings. In the channel 906, two side walls formed by two adjacent windings “breathe” as changes in the volume of the electroactive polymer layers 902 and 904 narrow or broaden the channel 906. The air gap may be configured to provide a constant or a varying distance between adjacent windings along the windings so that the cross-section of the channel 906 is kept constant or varies, e.g., increases or decreases from the inner end of the carrier plate 901 to its outer end or vice versa.

The description of embodiments has been presented for purposes of illustration and description. Suitable modifications and variations to the embodiments may be performed in light of the above description. The described systems are exemplary in nature, and may include additional elements and/or omit elements. As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The following claims particularly point out subject matter from the above disclosure that is regarded as novel and non-obvious.

1. An electroactive loudspeaker comprising:
a rigid, electrically conductive carrier plate comprising a first main surface and a second main surface, the first main surface and the second main surface being disposed on opposite sides of the carrier plate;
an electroactive polymer layer comprising a first main surface and a second main surface, the first main surface of the electroactive polymer layer being attached to the first main surface of the carrier plate;
an electrically conductive electrode layer attached to the second main surface of the electroactive polymer layer; wherein
the first main surface of the carrier plate has an area and the first main surface of the electroactive polymer layer has an area, the area of the first main surface of the carrier plate being larger than the area of the first main surface of the electroactive polymer layer; and
the first main surface of the electroactive polymer layer overlaps its entire area with the first main surface of the carrier plate.

2. The loudspeaker of claim 1, further comprising:
an additional electroactive polymer layer comprising a first main surface and a second main surface, the first main surface of the additional electroactive polymer layer being attached to the second main surface of the carrier plate;
an additional electrically conductive electrode layer attached to the second main surface of the additional electroactive polymer layer; wherein
the second main surface of the carrier plate has an area and the first main surface of the additional electroactive polymer layer has an area, the area of the second main surface of the carrier plate being larger than the area of the first main surface of the additional electroactive polymer layer; and
the first main surface of the additional electroactive polymer layer overlaps its entire area with the second main surface of the carrier plate.

3. The loudspeaker of claim 2, wherein the additional electrically conductive electrode layer has an area that is smaller than the area of the second main surface of the additional electroactive polymer layer.

4. The loudspeaker of claim 1, wherein the electrode layer has an area that is smaller than the area of the second main surface of the electroactive polymer layer.

5. The loudspeaker of claim 1, wherein the electroactive polymer layer includes a dielectric elastomer, an electrostrictive polymer, an electro-chemo-mechanical conducting polymer, mechano-chemical polymer or a piezoelectric polymer.

6. The loudspeaker of claim 1, wherein the carrier plate comprises metal, metal alloy or metalized ceramics.

7. The loudspeaker of claim 1, wherein at least one of the carrier plate, the electroactive polymer layer and an additional electroactive polymer layer has a cuboid shape.

8. The loudspeaker of claim 1, wherein at least one of the carrier plate, the electroactive polymer layer and an additional electroactive layer has a cylindrical shape.

9. The loudspeaker of claim 1, wherein the electroactive polymer layer comprises a multiplicity of electroactive sub-layers that are stacked with electrically conductive electrode sub-layers.

10. The loudspeaker of claim 1, wherein at least the carrier plate, the one electroactive polymer layer and the conductive electrode layer have a curved shape.

11. The loudspeaker of claim 1, wherein at least the carrier plate, the electroactive polymer layer and the conductive electrode layer are wound to form helical windings with an air gap between adjacent windings.

12. The loudspeaker of claim 11, wherein the air gap is configured to provide a constant or a varying distance between adjacent windings along the windings.

13. A loudspeaker system comprising at least one loudspeaker including the carrier plate, the electroactive polymer layer, and the conductive electrode layer, according to claim 1 and a housing in which the loudspeaker is disposed.

14. The loudspeaker system of claim 13, further comprising at least one non-electroactive loudspeaker.

15. The loudspeaker system of claim 14, wherein the at least one non-electroactive loudspeaker includes at least one of an electro-dynamic loudspeaker, electro-magnetic loudspeaker, electro-static loudspeaker, and a piezo-electric loudspeaker.

16. An electroactive loudspeaker comprising:
a conductive carrier plate including a first main surface and a second main surface, the first main surface and the second main surface being disposed on opposite sides of the carrier plate;
an electroactive polymer layer including a first main surface and a second main surface, the first main surface of the electroactive polymer layer being attached to the carrier plate;
a conductive electrode layer attached to the second main surface of the electroactive polymer layer; wherein
the first main surface of the carrier plate including an area and the first main surface of the electroactive polymer layer including an area, the area of the first main surface of the carrier plate being larger than the area of the first main surface of the electroactive polymer layer; and
the first main surface of the electroactive polymer layer overlaps its entire area with the first main surface of the carrier plate.

17. The loudspeaker of claim 1, further comprising:
an additional electroactive polymer layer comprising a first main surface and a second main surface, the first main surface of the additional electroactive polymer layer being attached to the second main surface of the carrier plate;
an additional electrically conductive electrode layer attached to the second main surface of the additional electroactive polymer layer; wherein
the second main surface of the carrier plate has an area and the first main surface of the additional electroactive polymer layer has an area, the area of the second main surface of the carrier plate being larger than the area of the first main surface of the additional electroactive polymer layer; and
the first main surface of the additional electroactive polymer layer overlaps its entire area with the second main surface of the carrier plate.

18. The loudspeaker of claim 17, wherein the additional electrically conductive electrode layer has an area that is smaller than the area of the second main surface of the additional electroactive polymer layer.

19. The loudspeaker of claim 1, wherein the electrode layer has an area that is smaller than the area of the second main surface of the electroactive polymer layer.

20. An electroactive loudspeaker comprising:
a carrier plate comprising a first main surface and a second main surface, the first main surface and the second main surface being disposed on opposite sides of the carrier plate;
an electroactive polymer layer comprising a first main surface and a second main surface, the first main surface of the electroactive polymer layer being attached to the carrier plate; and
an electrode layer attached to the second main surface of the electroactive polymer layer; wherein
the first main surface of the carrier plate includes an area and the first main surface of the electroactive polymer layer includes an area, the area of the first main surface of the carrier plate being larger than the area of the first main surface of the electroactive polymer layer; and
the first main surface of the electroactive polymer layer overlaps its entire area with the first main surface of the carrier plate.
